(19) United States
(12) Patent Application Publication
(10) Pub. No.: US 2008/0123041 A1
(43) Pub. Date: May 29, 2008

(54) ELECTRODE, DEVICE AND ELECTRONIC APPARATUS HAVING THE DEVICE

(75) Inventor: Akira FUJITA, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC LCD TECHNOLOGIES, LTD., Kanagawa (JP)

(21) Appl. No.: 11/928,411

(22) Filed: Oct. 30, 2007

(30) Foreign Application Priority Data
Nov. 27, 2006 (JP) 2006-318947

(51) Int. Cl. G02F 1/1345; H01K 1/02

(52) U.S. Cl. 349/152; 313/326

(57) ABSTRACT

An electrode arranged on a device includes a gap that is tapered toward an edge of the device and is formed from an end portion of the electrode to a different end portion thereof.

### INCORPORATION BY REFERENCE

This application is based upon and claims the benefit of priority from Japanese Patent Application No. JP 2006-318947, filed on Nov. 11, 2006, the disclosure of which is incorporated herein in its entirety by reference.

### BACKGROUND OF THE INVENTION

1. Technical Field

The present invention relates to an electrode, a device and an electronic apparatus having the device. In particular, the present invention relates to a protruding electrode, a device having the protruding electrodes for external connections and an electronic apparatus having a substrate on which the device is mounted by using an anisotropic conductive film.

2. Background Art

For a display device for a portable device such as a mobile phone, a flat panel display device such as a liquid crystal display (LCD) device is used widely. It is required that circuit elements for driving a flat panel display device are arranged in high density thereon, while a large-sized flat panel display device is developed.

A COG (chip on glass) mounting method is known as one of technologies for mounting a circuit element on the flat panel display device. In a COG mounting method, a semiconductor device (hereinafter, described as an IC) as a drive circuit is directly mounted on a substrate of a flat panel display device. Bumps formed on a connecting face of an IC and electrodes formed on a substrate are joined electrically and mechanically via an anisotropic conductive film (hereinafter, referred to as an ACF).

An ACF is a film which is capable of thermal compression bond and includes insulating resin and conductive particles dispersed therein. Conductive particles are, for example, spherical resin balls plated with Ni or Au of having 2 μm to 10 μm in diameter, or metallic particles. When an ACF is heated and pressed, insulating resin is softened and spread. Some of conductive particles are pressed and held between bumps of an IC and electrodes of the substrate. When insulating resin is hardened, conductive particles make electrical connection between bumps of an IC and electrodes of a substrate to electrically connect an IC with circuits in a substrate.

FIG. 18 shows a movement of an ACF, which includes insulating resin and conductive particles, on an IC 9, during mounting the IC 9 on a substrate. In FIG. 18, a bump line 30A and a bump line 30B are formed on a connecting face of the IC 9. Each bump 31 of the bump lines 30A and 30B includes a quadrangular cross section. The bumps 31 of the bump line 30A and the bump line 30B are arranged in a staggered configuration on the connecting face of the IC 9.

When the IC 9 on which the bumps 31 are formed is mounted on the substrate of a display device, the ACF 14 is arranged between the connecting face of the IC 9 and the substrate of the display device. When the ACF 14 is heated and pressed, the insulating resin included in the ACF 14 is softened. Then the insulating resin spreads on the connecting face of the IC 9 together with conductive particles 15. Some conductive particles 15 flow out of the bump lines together with the insulating resin. Further some other conductive particles 15 are sandwiched between the bumps 31 and the electrodes of the opposing substrate. The sandwiched conductive particles 15 make electrical connection between the bumps 31 of the IC 9 and the substrate of the display device.

Here, when a distance between the bump line 30A and the bump line 30B or a distance between the bumps 31 is short, a flow of the conductive particles 15 is disturbed by the bumps 31. As a result, the conductive particles 15 remain between the bump line 30A and the bump line 30B, and further between the bumps 31. Remaining conductive particles 15 therebetween have strong tendency to aggregate. Aggregated conductive particles 15 short-circuit the bumps 31 and make a short-circuit failure between the bump lines and between the bumps 31.

Here, in order to prevent short circuit failure caused by the conductive particles 15 aggregating, a technology to lower a filling density of the conductive particles 15 in the ACF 14 is proposed. In the technology, the number of captured conductive particles 15 between the bump 31 and the electrodes of the substrate decreases. Then, disconnection between the IC 9 and the display device may occur.

An another technology for suppressing the aggregation of the conductive particle 15 which causes short-circuit failures between the bump lines 30 and between the bumps 31 is disclosed in a related art (Japanese Patent Application Laid-Open No. 2001-358165). In the related art, cross section of a bump 32 is an ellipse as shown in FIG. 19. By using the bump 32 with an ellipsoidal cross-sectional shape, an ACF can smoothly flow outside bump lines of an IC 9. Thereby, it is prevented that conductive particles 15 stop between the bumps 32. Therefore short circuit failures between the bumps 32 are prevented.

### SUMMARY

An exemplary object of the present invention is to provide a protruding electrode which can suppress a short circuit occurrence and can perform an excellent electrical conduction between devices and to provide a device having the protruding electrodes and an electronic apparatus having the device.

An electrode arranged on a device according to an exemplary aspect of the invention includes a gap that is tapered toward an edge of the device and is formed from an end portion of the electrode to a different end portion thereof.

An electrode arranged on a device according to an exemplary aspect of the invention is for electrically connecting with an electronic apparatus via an anisotropic conductive film including conductive particles and a resin. The electrode includes a gap that is formed from an upper part of the electrode. A part of the resin which is softened by heating flows through the gap. The gap is tapered in a direction which the resin flows therethrough.

A device according to an exemplary aspect of the invention includes a plurality of electrodes arranged thereon. At least one of the electrodes having a gap that is tapered toward an edge of the device and is formed from an end portion of the electrode to a different end portion thereof.

A device according to an exemplary aspect of the invention includes a plurality of electrodes arranged thereon, the electrode connecting the device and an electronic apparatus electrically via an anisotropic conductive film including conductive particles and a resin. At least one of the electrodes includes a gap that is formed from an upper part of the electrode. A part of the resin which is softened by heating flows through the gap, and the gap is tapered in a direction which the resin flows therethrough.

An electronic apparatus to an exemplary aspect of the invention includes a conductive part and a device including a plurality of electrodes electrically connecting with the conductive part via an anisotropic conductive film including conductive particles and a resin. At least one of the electrodes has a gap which is formed from an upper part of said electrodes. A part of the resin which is softened by heating flows through the gap and the gap is tapered in a direction which the resin flows therethrough.

### BRIEF DESCRIPTION OF THE DRAWINGS

Exemplary features and advantages of the present invention will become apparent from the following detailed description when taken with the accompanying drawings in which:

FIG. 1A is a top view of an IC according to a first exemplary embodiment of the present invention;

FIG. 1B is a partial top view of the IC according to the first exemplary embodiment of the present invention;

FIG. 2 is a partial perspective view of the IC with a bump according to the first exemplary embodiment of the present invention;

FIG. 3 is a perspective view of a display device having the IC thereon according to the first exemplary embodiment of the present invention;

FIG. 4 is a partial perspective view of a display device in mounting the IC according to the first exemplary embodiment of the present invention;

FIG. 5 is a partial top view of an area where a thin film transistor substrate projects according to the first exemplary embodiment of the present invention;

FIG. 6 is a partial sectional view of a display device according to a first exemplary embodiment of the present invention;

FIG. 7 is a partial top view of the IC in mounting the IC according to the first exemplary embodiment of the present invention;

FIG. 8 is a partial perspective view of the IC in mounting the IC according to the first exemplary embodiment of the present invention;

FIGS. 9A through 9E are process diagrams showing a formation process of a bump according to the first exemplary embodiment of the present invention;

FIGS. 10A through 10E are process diagrams showing a formation process of a bump with a gap according to the first exemplary embodiment of the present invention;

FIG. 11 is a perspective view of a different IC according to the first exemplary embodiment of the present invention;

FIG. 12A is a perspective view showing a structure of a bump according to a second exemplary embodiment of the present invention.

FIG. 12B is a top view showing the structure of the bump according to the second exemplary embodiment of the present invention.

FIG. 12C is a bottom view showing the structure of the bump according to the second exemplary embodiment of the present invention.

FIG. 12D is a left side view showing the structure of the bump according to the second exemplary embodiment of the present invention;

FIG. 12E is a right side view showing the structure of the bump according to the second exemplary embodiment of the present invention;

FIG. 13A is a perspective view showing a structure of a different bump according to the second exemplary embodiment of the present invention;

FIG. 13B is a top view showing a structure of a different bump according to the second exemplary embodiment of the present invention;

FIG. 13C is a bottom view showing a structure of a different bump according to the second exemplary embodiment of the present invention;

FIG. 13D is a left side view showing a structure of a different bump according to the second exemplary embodiment of the present invention;

FIG. 13E is a right side view showing a structure of a different bump according to the second exemplary embodiment of the present invention;

FIG. 14 is a partial top view of an IC in mounting the IC according to a third exemplary embodiment of the present invention;

FIG. 15 is a partial top view of a different IC in mounting the IC according to the third exemplary embodiment of the present invention;

FIG. 16A is a perspective view showing a structure of a bump according to a fourth exemplary embodiment of the present invention;

FIG. 16B is a top view showing a structure of the bump according to the fourth exemplary embodiment of the present invention;

FIG. 16C is a right side view showing the structure of the bump according to the fourth exemplary embodiment of the present invention;

FIG. 17A is a perspective view showing a structure of a different bump according to a fifth exemplary embodiment of the present invention;

FIG. 17B is a top view showing a structure of a different bump according to a fifth exemplary embodiment of the present invention;

FIG. 17C is a right side view showing a structure of a different bump according to a fifth exemplary embodiment of the present invention;

FIG. 18 is a partial top view of a semiconductor device in mounting the semiconductor device of a related art; and

FIG. 19 is a partial top view of a portion in which a bump of a semiconductor device was formed according to a related art 1.

### EXEMPLARY EMBODIMENT

Exemplary embodiments of the present invention will now be described in detail in accordance with the accompanying drawings.

### 1. First Exemplary Embodiment

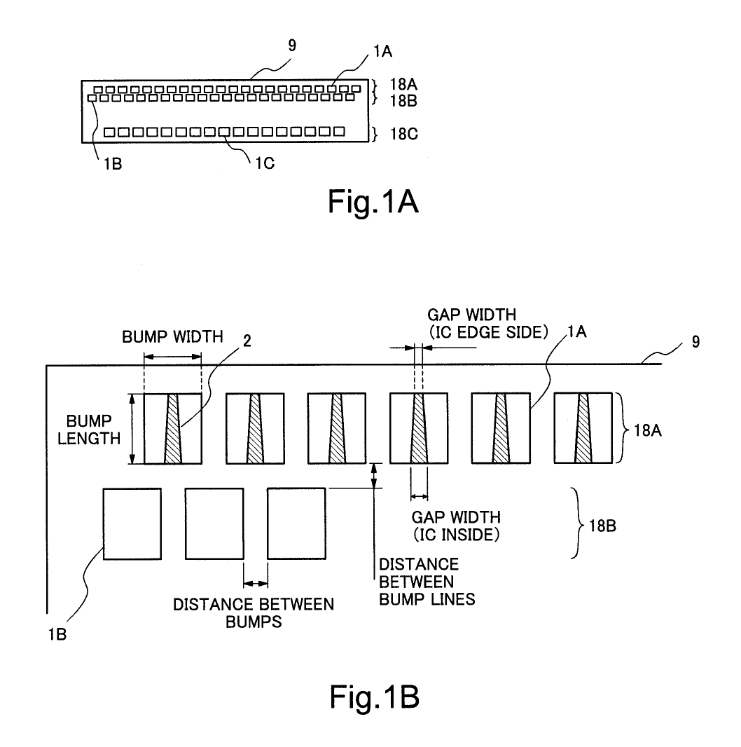

A first exemplary embodiment will be described below using FIGS. 1 to 10. FIG. 1A shows a top view of a bump structure of a semiconductor device according to the exemplary embodiment. As shown in FIG. 1A, a plurality of bumps (i.e. protruding electrodes) are arranged in a straight line on a connecting face of an IC 9 according to the exemplary embodiment. In FIG. 1A, a bump line 18C including bumps 1C along an edge line of IC 9 inside one long side thereof is formed on a connecting face of the IC 9. And two lines of bump lines 18A and 18B are formed along an edge line of the IC 9 inside the other long side thereof. As shown in FIG. 1A, in the exemplary embodiment, a distance between bumps 1C is longer than a distance between bumps 1A and than a distance between bumps 1B.

FIG. 1B is a partial top view of a portion in which the bump lines 18A and 18B on the connecting face of the IC 9 are arranged. In FIG. 1B, the bumps 1A of the bump line 18A and the bumps 1B of the bump line 18B are arranged in a staggered configuration on the connecting face of the IC 9. Each of the bumps 1A in the bump line 18A arranged on the edge side of the IC 9 includes two parts whose cross-sections are in the shape of a trapezoid. The bump 1A is divided into two parts by a gap 2 extending in a short side direction of the IC 9. The gap 2 is tapered such that a width of the gap 2 becomes small gradually toward a long edge side of the IC 9. A horizontal cross-sectional shape of the bump 1B of a bump line 18B arranged inside the bump line 18A is a square or a rectangle.

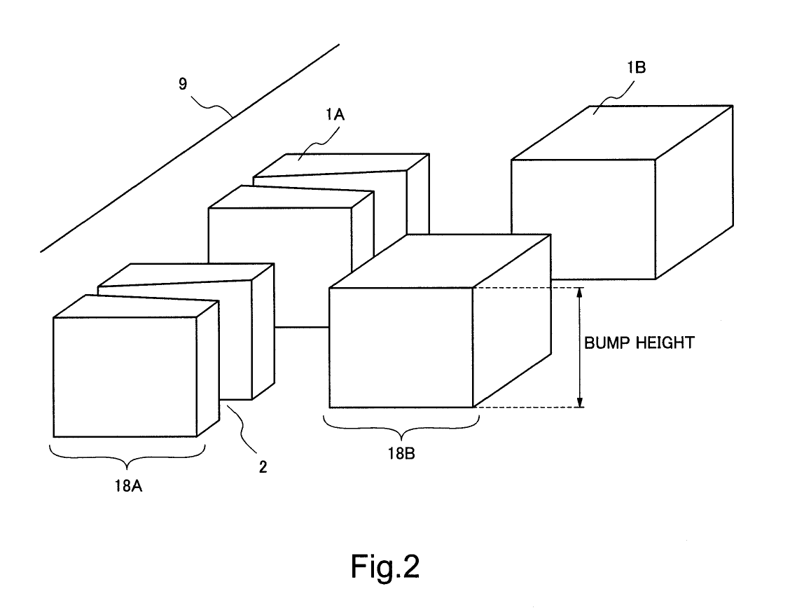

A partial perspective view of a connecting face of an IC 9 is shown in FIG. 2. Bump lines 18A and 18B are formed on the connecting face of the IC 9. In FIG. 2, while a bump 1B is formed into a quadrangular prism, a bump 1A includes two trapezoid poles divided by a tapered gap 2.

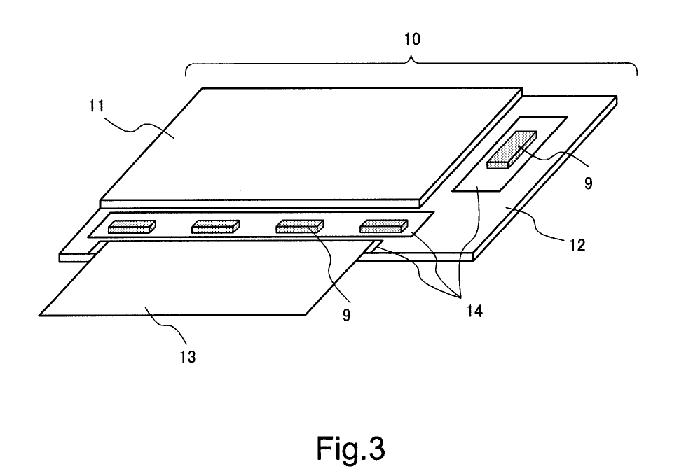

Next, a display device on which an IC 9 with bumps is mounted will be described. FIG. 3 shows a perspective view of the display device according to the exemplary embodiment. The display device includes the IC 9 for driving a liquid crystal and an FPC (flexible printed circuit) 13 for transmitting a drive signal and an electric power to the IC 9 on an LCD panel 10. The LCD panel 10 includes a substrate (hereinafter, referred to as a TFT substrate) on which switching elements such as TFT (thin film transistors) or the like are formed and an opposed substrate (hereinafter, referred to as a CF substrate) on which CF (color filters) for performing a color display are formed. A liquid crystal layer (not illustrated) is held between the TFT substrate 12 and the CF substrate 11.

In FIG. 3, a TFT substrate 12 projects from the CF substrate 11, and the IC 9 and the FPC 13 are mounted on a projecting area. The IC 9 and the FPC 13 are mounted on the projecting area of the TFT substrate 12 via an ACF 14.

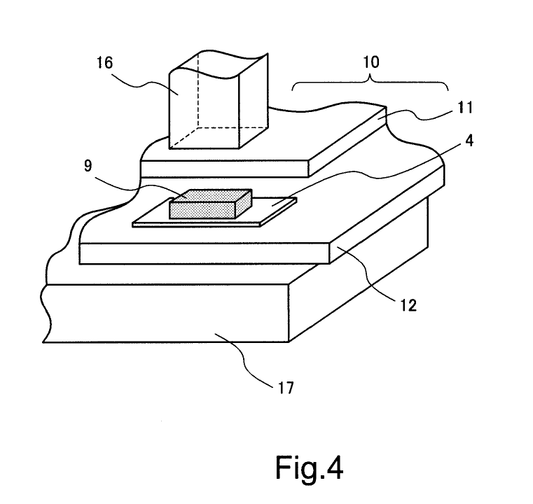

FIG. 4 is a partial perspective view of a step of mounting the IC 9 on the projecting area of the TFT substrate 12 using the ACF 14. The LCD panel 10 is set on a compression bonding stage 17. When the IC 9 is mounted on the projecting area of the TFT substrate 12 of the LCD panel 10, first, the ACF 14 is arranged on an area where the IC 9 is mounted on the projecting area of the TFT substrate 12. Next, a connecting face of the IC 9 is put on the ACF 14. Then, bumps formed on the IC 9 are opposed to electrode pads formed on the TFT substrate 12. A compression bonding tool 16 presses a top of the IC 9 via a buffering material (not illustrated) in such a configuration.

When the ACF 14 is heated and pressed by the compression bonding tool 16, insulating resin in the ACF 14 is softened and spread. Conductive particles are also spread with the insulating resin and some of the spread conductive particles are held and sandwiched between the bumps of the IC 9 and the electrode pads of the TFT substrate 12. When the insulating resin is hardened, the IC 9 is fixed on the projecting area of the TFT substrate 12. The conductive particles sandwiched between the bumps of the IC 9 and the electrode pads of the TFT substrate 12 aggregate, and the IC 9 and the TFT substrate 12 are connected electrically.

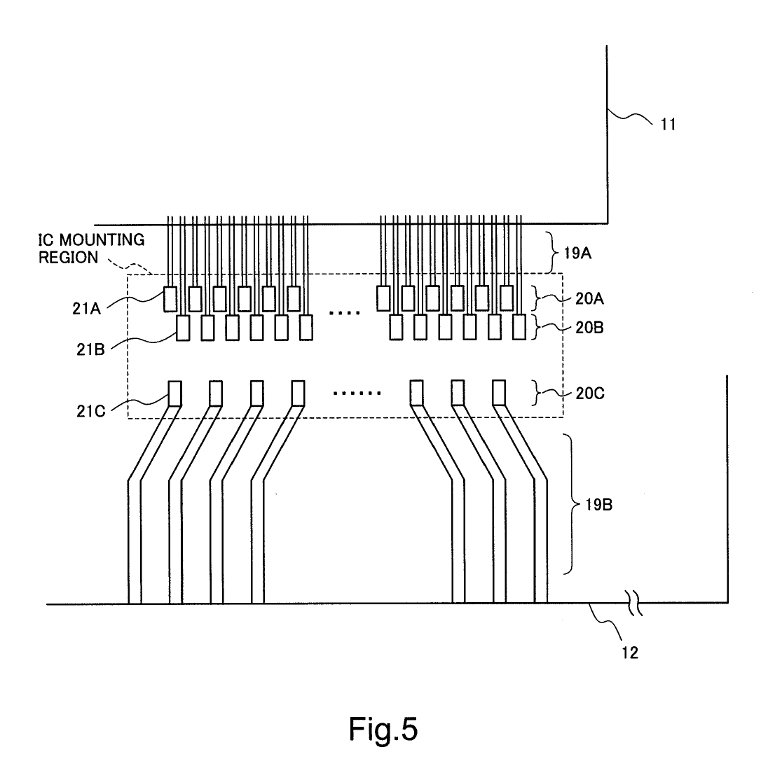

A mounting structure of the IC 9 will be described in detail using FIGS. 5 to 8. FIG. 5 is a partial top view of the projecting area of the TFT substrate 12 where an IC 9 is mounted. In FIG. 5, a plurality of output wiring patterns 19A are formed on the side of a CF substrate 11 in an area in which the IC 9 is mounted (hereinafter, referred to as an IC mounting region). The output wiring pattern 19A is connected to a TFT device (not illustrated).

Electrode pads 21A and 21B are formed at tip portions of output wiring patterns 19A. Each of the electrode pads 21A in an electrode pad line 20A is connected with a bump 1A in a bump line 18A of the IC 9. Each of the electrode pads 21B in an electrode pad line 20B is connected with a bump 1B in a bump line 18B of the IC 9. The electrode pads 21A and the electrode pads 21B are formed so as to be able to oppose the bumps 1A and the bumps 1B of the IC 9, respectively. The electrode pad 21A and the electrode pad 21B are arranged in a staggered configuration on an IC mounting region.

On the other hand, a plurality of input wiring patterns 19B connected to a FPC 13 are formed on a TFT substrate 12 edge side of an IC mounting region. Electrode pads 21C connected with bumps 1C of the IC 9 are formed at tip portions of input wiring patterns 19B. The electrode pads 21C are arranged so as to oppose the bumps 1C.

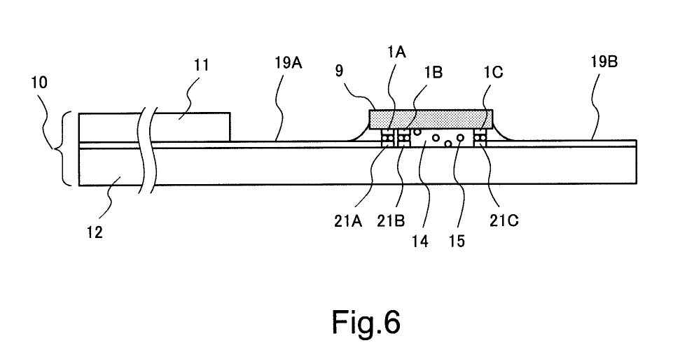

FIG. 6 is a partial sectional view of the display device in which the IC 9 is mounted on the TFT substrate 12. In FIG. 6, the input wiring patterns 19B connected to the FPC 13 (not illustrated) and the output wiring pattern 19A connected to the TFT device (not illustrated) are formed on the TFT substrate 12. The electrode pads 21C are formed at tip portions of the input wiring pattern 19B and the electrode pad 21A and the electrode pad 21B is formed at tip portions of the output wiring patterns 19A.

On the other hand, in FIG. 6, bumps 1A, 1B and 1C are formed on the connecting face of the IC 9. And the bumps 1A, the bumps 1B and the bumps 1C are connected with the electrode pads 21A, the electrode pads 21B and the electrodes pad 21C via the ACF 14 respectively.

When the IC 9 is mounted on the TFT substrate 12, a face of the IC 9 on which the bumps are formed is set on the ACF 14 arranged on the TFT substrate 12. The ACF 14 is hot-pressed in such a configuration. When the ACF 14 is heated, insulating resin therein is softened and flows out toward an outside from a lower part of the IC 9 together with conductive particles 15.

Some of the conductive particles 15 which flow out are captured and sandwiched between the bumps and the electrode pads of the TFT substrate 12. When the conductive particles 15 sandwiched therebetween aggregates, the FPC 13, the IC 9 and the TFT substrate 12 are connected electrically via the aggregated conductive particles. When the insulating resin of the ACF 14 is hardened, the IC 9 is fixed on the TFT substrate 12.

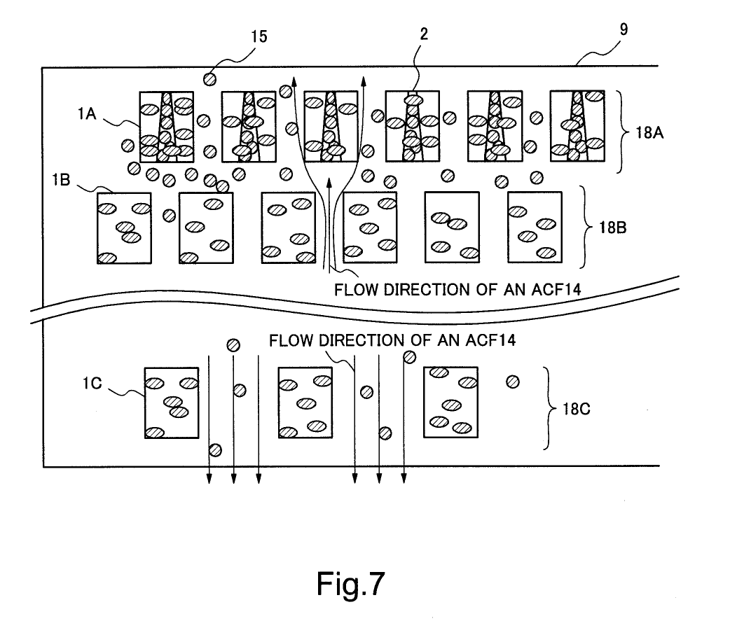

FIG. 7 shows movement of the insulating resin and the conductive particle 15 of the ACF 14 on the IC 9 during a mounting process of the IC 9 into the TFT substrate 12. In FIG. 7, the bump line 18C is arranged in a single row near one edge side of the IC 9. The bumps 1C of the bump line 18C are formed so that a distance therebetween is long. On the other hand, the bump line 18A and the bump line 18B are arranged near the other edge side of the IC 9. The bumps 1A of the bump line 18A and the bumps 1B of the bump line 18B are arranged in a staggered configuration with a shorter distance than that of the bumps 1C. Here, in the IC 9 according to the exemplary embodiment, a tapered gap 2 is formed in each bump 1A of the bump line 18A which is arranged outside of the bump line 18B.

In FIG. 7, the insulating resin and the conductive particle 15 in the ACF 14 flow smoothly from a lower part of the IC 9 toward an outside thereof through a distance between the bumps IC of the bump line 18C, during mounting the IC 9 on the TFT substrate 12 by the hot-pressing. Some of the conductive particles 15 which flow out are captured and sandwiched between the bumps 1C and the opposing electrode pads 21C. When the captured conductive particles 15 aggregate, the IC 9 and the input wiring pattern 19B connected to the FPC 13 are connected electrically.

On the other hand, a part of the insulating resin and some of the conductive particles 15 in the ACF 14 flow through a distance between the bumps 1B toward the bump line 18A during the hot-pressing. Here, some of the conductive particles 15 are captured and sandwiched between the bumps 1B and the opposing electrode pads 21B.

Further, a part of the insulating resin and some of the conductive particles 15 flow out of a lower part of the IC 9 through a distance between the bumps 1A or the gaps 2 formed in each of the bumps 1A. Here, some of the conductive particles 15 which flow to the bump line 18A side are captured and sandwiched between the bumps 1A and the opposing electrode pads 21A.

When the conductive particles 15 captured between the bumps 1B and the electrode pads 21B and between the bumps 1A and the electrode pads 21A aggregate, the IC 9 and the output wiring patterns 19A connected to the TFT device are connected electrically.

Many conductive particles 15 which enter the gap 2 formed in the bump 1A cannot pass through the tapered gap 2 and stop thereinside. The many conductive particles 15 which remain in the gap 2 readily aggregate therein. And when the aggregated conductive particles 15 fill the tapered gap 2 to reach to an upper surface of the bump 1A, a upper surface area of the bump 1A in which the gap 2 is formed becomes substantially equal to an upper surface area of the bump 1B or the bump 1C in which no gap is formed. Therefore sufficient conductive particles 15 may be held between the bumps 1A and the opposing electrode pads 21A. Thereby, excellent electrical connection is given between the bumps 1A having the tapered gap 2 and the electrode pads 21A. Further, because many conductive particles 15 are captured in the tapered gap 2 while small conductive particles and the insulating resin passes therethrough, aggregated conductive particles between the bumps 1A and between the bumps 1A and 1B may decrease or disappear.

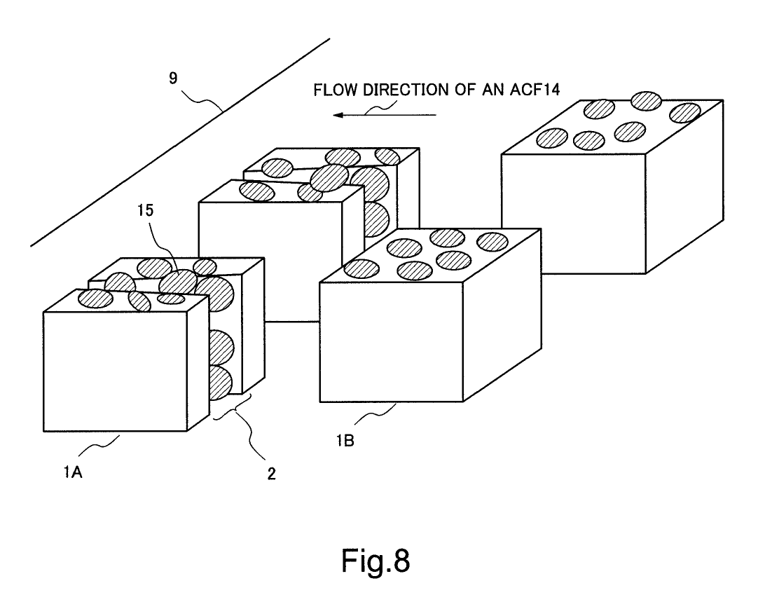

FIG. 8 shows a partial perspective view showing that the conductive particles 15 enter and fill the gap 2 to reach the upper surface area thereof. In FIG. 8, the conductive particles 15 which cannot flow out of the gap 2 are piled up in the gap 2. When the conductive particle 15 piled up in the gap 2 reaches to the upper surface in the gap 2, the conductive particles 15 are held between the bumps 1A and the electrode pads 21A of the opposing TFT substrate 12. Therefore, the upper surface area of the bump 1A having the gap 2 becomes substantially equal to the upper surface area of the bump 1B and the bump 1C each having no gap.

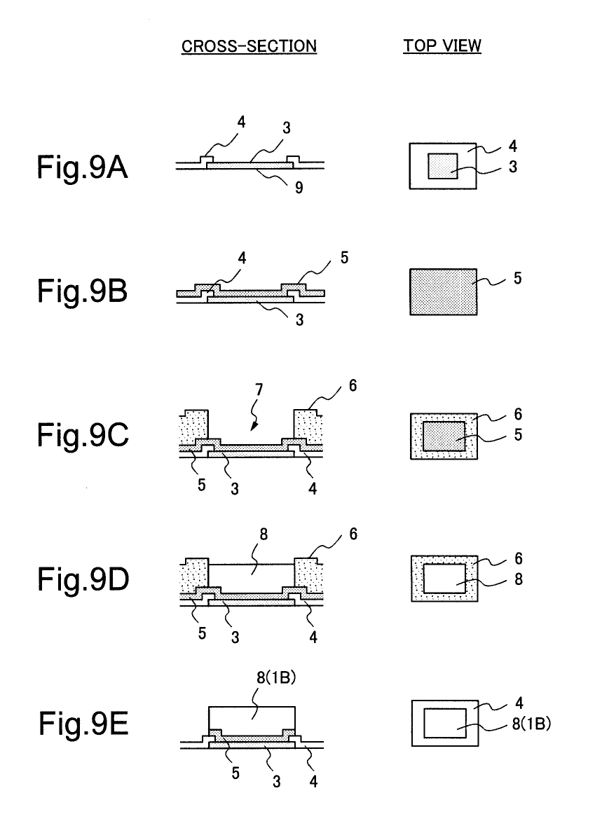

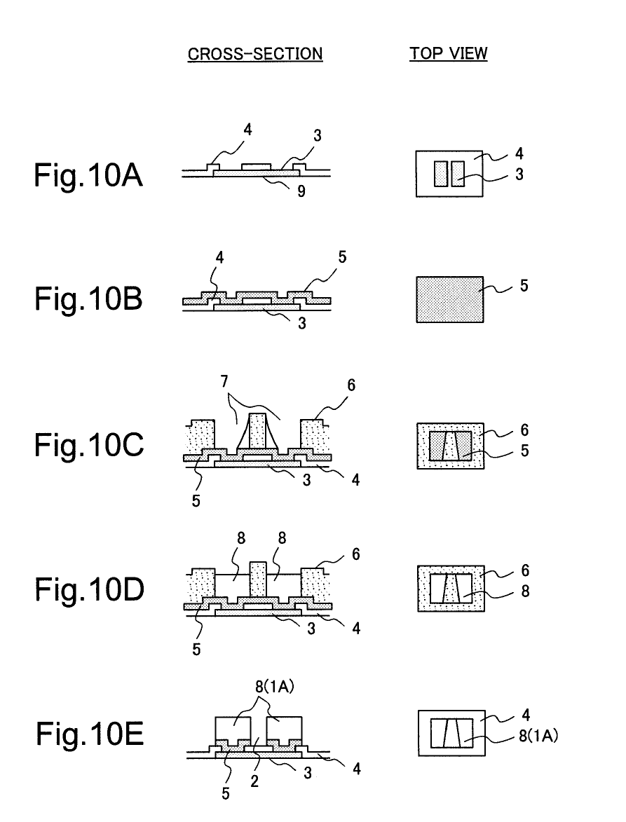

Next, formation processes of bumps will be described with reference to FIGS. 9A through 9E and FIGS. 10A through 10E. FIGS. 9A through 9E show the formation process of bumps 1B and bumps 1C with square poles in which a gap 2 is not formed. FIGS. 10A through 10E show formation processes of bumps 1A with a gap 2 and two trapezoid poles. In FIGS. 9A through 9E and FIGS. 10A through 10E, a left side of each of Figures is a cross sectional view of the bump and a right side thereof is a top view of the bump. There are many methods such as a photolithographic method, a plating method or a solder cream transfer printing method as the forming method for the bump. A method for forming the bump by gold (Au) using the photolithographic method and the plating method will be described below.

First, the formation process of the bump 1B in which the gap 2 is not formed will be described using FIGS. 9A through 9E. In FIG. 9A, an Al pad 3 is formed on a part of an upper surface of an IC 9 where the bump 1B is formed. Moreover, an area except the area where the bump 1B is formed is covered with a passivation protection film 4 (for example, Si3N6). In a top view in FIG. 9A, a square-like Al pad 3 is exposed in a formation area for the bump 1B.

Next, as shown in FIG. 9B, a barrier metal 5 (for example, Ti, Pd, Cr, Cu) is deposited on the passivation protection film 4 and the Al pad 3. As shown in FIG. 9C, a film resist 6 is formed on an area other than the area where the bump 1B is formed using the photolithographic method. In FIG. 9C, a square-like opening 7 is formed in the area where the bump 1B is formed.

After washing an inside of the opening 7 using an acid, as shown in FIG. 9D, an Au plating film 8 is formed in the opening 7. As shown in FIG. 9E, the film resist 6 is removed, and then the barrier metal 5 is removed by etching, and the square pole-shaped bump 1B formed by Au is obtained.

Next, formation processes of the bump 1A having the tapered gap 2 will be described using FIGS. 10A through 10E. In a top view in FIG. 10A, an Al pad 3 is formed on a part of the upper surface of the IC 9 area where the bump 1A and the gap 2 are formed. An area except the area where the bump 1A is formed is covered with the passivation protection film 4. Here, an area where the gap 2 is formed is also covered with the passivation protection film 4. Such process prevents the Al pad 3 in the area where the gap 2 is formed from being exposed in the removal step for the film resist 6 and the etching removal step for the barrier metal 5 after forming the Au plating film 8. In FIG. 10A, Al pads 3 having two square shapes are exposed in the formation area for the bump 1A.

Next, as shown in FIG. 10B, the barrier metal 5 is deposited on the passivation protection film 4 and the Al pad 3. As shown in FIG. 10C, the film resist 6 is formed on an area except the area where the bump 1A is formed using a photolithographic method. Here, the film resist 6 is also formed on the area where the gap 2 is formed. In FIG. 10C, two openings 7 which are trapezoidal in horizontal cross sections are formed on the area where the bump 1A is formed.

After washing an inside of the openings 7 using an acid, as shown in FIG. 10D, an Au plating film 8 is formed in the openings 7. As shown in FIG. 10E, the film resist 6 is removed, and the barrier metal 5 is remove by etching, and a bump 1A having the tapered gap 2 is obtained.

In the exemplary embodiment, the square pole-shaped bumps 1B and 1C are formed on the connecting face of the IC 9 by the method shown in FIGS. 9A through 9E. The bump 1A including two trapezoidal poles and the gap 2 is formed on the connecting face of the IC 9 by the method shown in FIGS. 10A through 10E. The bump 1A is formed on the connecting face of the IC 9 such that an opening with short width of the tapered gap 2 faces to the long side edge side of the IC 9. Here, the bumps 1A, 1B and 1C can be formed simultaneously.

Although the bumps are formed of the gold (Au) in the exemplary embodiment, the bumps may be formed of a gold alloy including other metal, solder, etc. A size of the bumps and the gap 2 is not limited in particular. In the exemplary embodiment, in FIG. 1B and FIG. 2, the bump is set to 25 μm in width, 80 μm in length and 15 μm in height. Distance between the bumps 1A and 1B is set to 23 μm, and the distance between the bumps 1C is set to 100 μm. A distance between the bump line 18A and the bump line 18B is set to 20 μm. A long width of the tapered gap 2 is set to 7 μm and a short width thereof is set to 3 μm, because an average diameter of conductive particles 15 included in the ACF 14 is substantially 4 μm. The widths can be set appropriately according to a diameter of the conductive particles 15 in the ACF 14, a viscosity of the insulating resin thereof or the like.

In the exemplary embodiment, although the bumps 1A, 1B and 1C have the same outer sizes, an outer size of the bump may be changed for each bump line. In the same bump line, the outer size of each bump may be changed.

In the exemplary embodiments, although the tapered gap 2 is formed only in the bump 1A of the bump line 18A, the gap 2 may be formed in the bump 1B of the bump line 18B and the bump 1C of the bump line 18C.

Moreover, a shape of the gap 2 formed in each bump 1A of the bump line 18A is identical. Sizes of the width of the gap 2 may be changed for each bump 1A. The gap 2 formed in the center of the bump line 18A may have a wide opening because the conductive particles 15 tends to be collected therein.

In the exemplary embodiments, a slit-shaped gap 2 which reaches a surface of the IC 9 from a top surface of a bump 1A is formed, and the bump 1A is separated into two parts completely. However the shape of the gap 2 is not limited to such a shape. For example, the gap 2 may be a shallow gap having a depth shorter than height of the bump 1A. Then, the bump 1A is not completely separated into two parts. When a shallow gap is formed in the bump 1A, after forming a square pole-shaped bump 1A, a resist pattern exposing an area for the gap 2 is formed, and the bump 1A may be etched by a predetermined depth using the resist pattern as a mask.

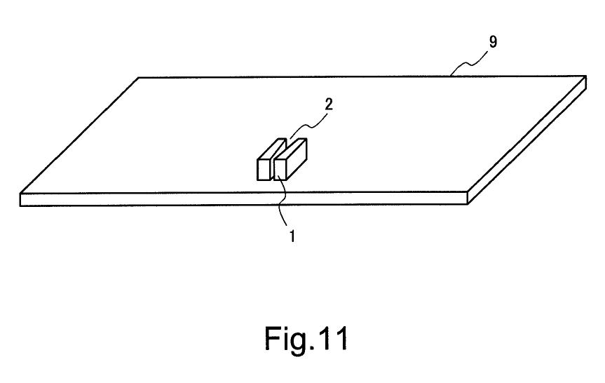

Here, FIG. 11 shows a perspective view of the IC 9 having a basic configuration of the invention. The IC 9 shown in FIG. 11 can be connected with an electronic apparatus electrically. One bump 1A for connecting with an electronic apparatus electrically is formed in a center of a long side edge of a connecting face of the IC 9. The bump 1A is divided into two parts by a gap 2 which is extended to an edge portion of the IC 9 from a center portion thereof. The gap 2 is formed in a so-called tapered manner in which a width of the gap 2 gradually decreases toward the edge portion of the IC 9.

When the IC 9 is mounted on the TFT substrate 12 via the ACF 14, the bump 1A having the tapered gap 2 is used in the exemplary embodiment as described above. Because small conductive particles 15 which reach just before the bump 1A during mounting flow smoothly out of the IC 9 through the gap 2 and many conductive particles are captured in the gap 2, it is suppressed that the conductive particles 15 aggregate between the bumps 1A and between the bump lines. Therefore, it can be suppressed that a short circuit failure occurs between the bumps and between the bump lines.

Many conductive particles 15 captured in the gap 2 aggregate therein. When the aggregated conductive particles 15 in the gap 2 reach to an upper surface of the bump 1A, an area of the upper surface thereof is substantially equal to an upper surface area of the bump 1B having no gap. Therefore, the conductive particles 15 are readily held and sandwiched between the bump 1A and an electrode pad of a TFT substrate. Accordingly an excellent electrical connection can be made between the IC 9 and the TFT substrate 12.

### 2. Second Exemplary Embodiment

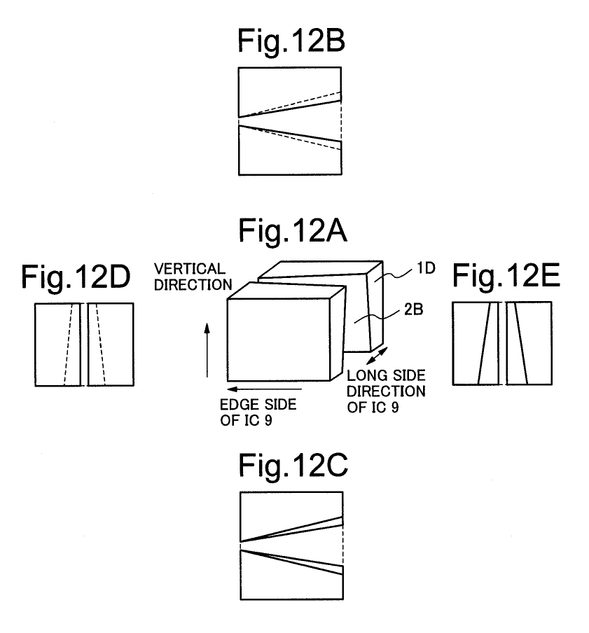

Next, a second exemplary embodiment will be described. FIG. 12A is a perspective view of a bump 1D of a device according to the exemplary embodiment. FIG. 12B is a top view of the bump 1D, and FIG. 12C is a bottom view of the bump 1D. FIG. 12D is a left side view of the bump 1D, and FIG. 12E is a right side view of the bump 1D.

In the first exemplary embodiment, a tapered gap 2 whose width gradually decreases toward an edge side of an IC 9 is formed in a bump 1A. In contrast, in the second exemplary embodiment, as shown in FIGS. 12A through 12E, a gap 2B is tapered toward an edge side of an IC 9 and further is tapered toward an upper surface of the 1D from a bottom thereof.

In FIG. 12A and FIG. 12E, a width of the gap 2B in a vertical direction of the side remote from the edge side of the IC 9 decreases gradually toward the upper surface from the bottom of the bump 1D. When FIG. 12B and FIG. 12C are compared, while lengths of an upper base in the trapezoidal gap 2B in FIG. 12B and FIG. 12C are equal, a lower base in FIG. 12C is longer than that in FIG. 12B. Here, in FIG. 12B, the length of the upper base of the trapezoid which is a horizontal cross section shape in the gap 2B is desirable to be shorter than an average diameter of conductive particles 15.

By setting the width of the gap 2B at the side thereof remote from the edge side of the IC 9 to decrease gradually toward the upper surface from the bottom of the bump 1D, the ACF 14 entered the inside of the gap 2B tends to flow up. Therefore, the ACF 14 easily enters the gap 2B. On the other hand, because the length of the upper base of the trapezoid is shorter than the average diameter of the conductive particle 15, many conductive particles 15 which enter the gap 2B can not escape to an upper direction and aggregate densely inside the gap 2B. The densely aggregated conductive particles 15 overflow from the upper surface of the gap 2 and reach an electrode of the TFT substrate to make an excellent connection between the IC 9 and the TFT substrate.

By forming the gap 2B whose width in a vertical direction of the side remote from the edge side of the IC 9 decreases gradually toward the upper surface from the bottom of the bump 1D, it is suppressed that a short circuit failure occurs between the bumps and between the bump lines. Moreover, better electrical conduction can be given to between the IC 9 and the TFT substrate.

The formation process for the bump 1D according to the second exemplary embodiment is almost the same as that for the bump 1A according to the first exemplary embodiment. That is, an Al pad 3 is formed in an area where a bump 1D and a gap 2B are formed, and an area other than the area where the bump 1D is formed is covered with a passivation protection film 4. Then a barrier metal 5 is deposited on the passivation protection film 4 and the Al pad 3.

Moreover, a film resist 6 is formed in an area other than the area where the bump 1D is formed. Here, in the formation process of the bump 1D according to the second exemplary embodiment, the film resist 6 having a horizontal cross section of a wedge shape is formed in an area corresponding to the gap 2B. A portion with a large width of the wedge-shaped cross section of the film resist 6 becomes narrow toward a vertical upper part thereof.

And an Au plating film 8 is formed inside the opening 7 of the film resist 6, and the film resist 6 and the barrier metal 5 are removed. Thus, the bump 1D having the gap 2B shown in FIG. 12A through 12E can be formed. The gap 2B has the tapered cross-sectional shape and the width in a vertical direction of the portion with the tapered shape large width becomes narrow toward the upper surface from the bottom of the bump 1D. The bump 1D is formed on the connecting face of the IC 9 such that the narrow side of a tapered gap 2 faces to the long side edge side thereof.

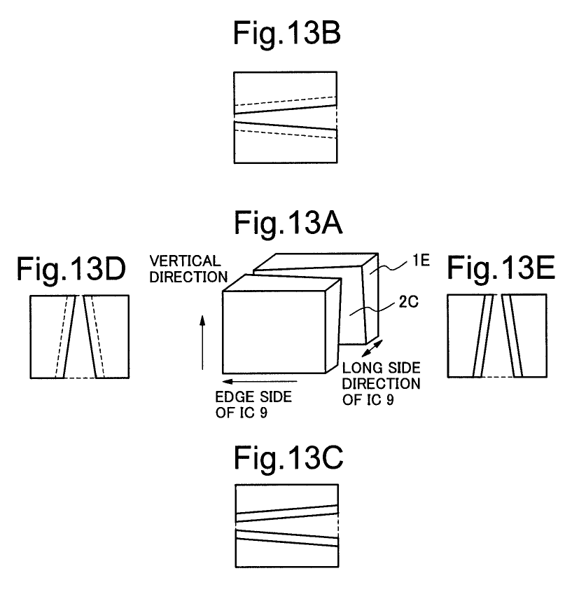

A modification of the second exemplary embodiment is shown in FIGS. 13A through 13E. FIG. 13A is a perspective view of a bump 1E. FIG. 13B is a top view of the bump 1E, and FIG. 13C is a bottom view thereof. FIG. 13D is a left side view of the bump 1E, and FIG. 13E is a right side view thereof. In the bump 1D shown in FIGS. 12A through 12E, the gap 2B is formed so that the large width portion of the tapered shape becomes narrow toward the upper surface from the bottom of the bump 1D in a vertical direction. On the other hand, the gap 2C in the bump 1E shown in FIGS. 13A through 13E is formed so that widths of openings of the gap 2C appeared on three faces of the bump 1E including the upper surface thereof are tapered.

In the gap 2C shown in FIGS. 13A through 13E, the conductive particles 15 which enter the gap 2C flow out easily and are difficult to aggregate enough to reach to the top of the gap 2C. Therefore, it is desirable to apply the bump 1E in a case that a short circuit failure is easy to generate.

### 3. Third Exemplary Embodiment

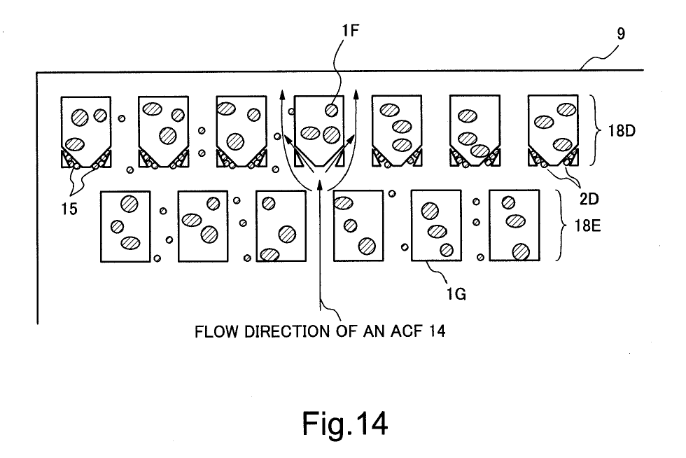

A third exemplary embodiment of the present invention will be described. FIG. 14 is a partial top view in a connecting face of an IC 9 during mounting the IC 9 according to the third exemplary embodiment into a substrate. A bump line 18D including a plurality of bumps 1F with gaps 2D and a bump line 18E including a plurality of bumps 1G each having a square cross-section are formed on an IC 9.

As shown in FIG. 14, the gap 2D is formed in each bump 1F in an approximately V-shaped form with respect to the square cross-section of the bump 1F. The gap 2D includes two portions which extend to two sides opposite to each other in the bump 1F from a side of the bump 1F adjacent to the two sides. Here, at least one of two portions of the gap 2D may be tapered toward an edge side of an IC9.

By forming the V-shaped gap 2D in each bump 1F of the bump line 18D, an ACF 14 located between the bump line 18D and the bump line 18E can readily move to an area between the bumps 1F of the bump line 18D. By forming the V-shaped gap 2D, an occupied area by the gap 2D on the upper surface area of the bump 1F can be reduced. Therefore, the bump 1F can have enough upper surface area to capture conductive particles 15. Because the width of each portions of the gap 2D is tapered toward the edge of the IC 9, conductive particles 15 can be captured and aggregated efficiently.

A formation process for the bump 1F with the V-shaped gap 2D is almost the same as that for the bumps 1A and 1D according to first and second exemplary embodiments. In the exemplary embodiment, a film resist 6 is formed such that an opening 7 becomes a V-shaped during forming the film resist 6. Further, each of two portions of the gap 2D may be formed into a shallow form so that the gap 2D does not reach a bottom of the bump 1F.

The ACF 14 can flow between the bumps 1F and the upper surface area for capturing the conductive particles 15 does not greatly decreases, even if the V-shaped gap 2D is formed in the bump 1F. The conductive particles 15 can be accumulated efficiently in the gap 2D, since at least one of two portions of the gap 2D is tapered toward the edge of the IC 9.

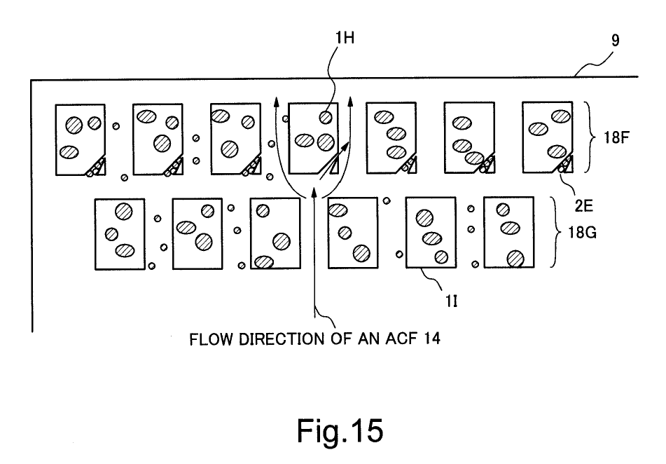

A modification of the third exemplary embodiment is shown in FIG. 15. In FIG. 15, a bump line 18F including a plurality of bumps 1H with gaps 2E and a bump line 18G including a plurality of bumps 1I each having a square cross-section are formed on an IC 9. In FIG. 15, one slash-like gap 2E is formed in each bump 1H of a bump line 18F. The gap 2E is extended from a side of the bump 1H to a side adjacent thereto. A width of the gap 2E is tapered toward the edge of IC 9. It is desirable to form the bump 1H with the gap 2E in an area through which a softened insulating resin of the ACF 14 flows smoothly during hot-pressing.

4. Fourth Exemplary Embodiment

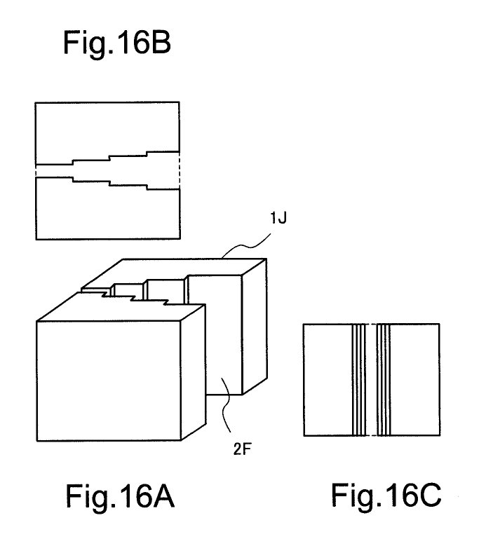

Next, other exemplary embodiment of the present invention will be described. FIG. 16A is a perspective view of a bump 1J according to a fourth exemplary embodiment. FIG. 16B is a top view of the bump 1J, and FIG. 16C is the right side view of the bump 1J. In FIG. 16A through 16C, a gap 2F in the bump 1J is tapered in a stepwise form.

The conductive particles 15 which enter the step shape gap 2F tend to remain at the step portion in the gap 2F. Thus the conductive particles 15 tend to aggregate inside the gap 2F and the aggregated conductive particles 15 easily fill the gap 2F to reach a surface thereof. Therefore, an excellent connection can be given between devices.

5. The Fifth Exemplary Embodiment

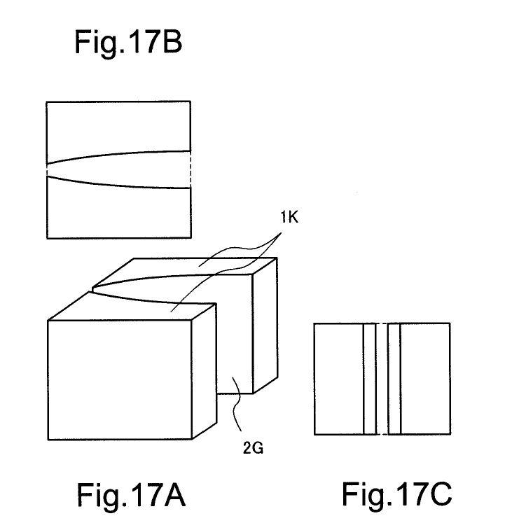

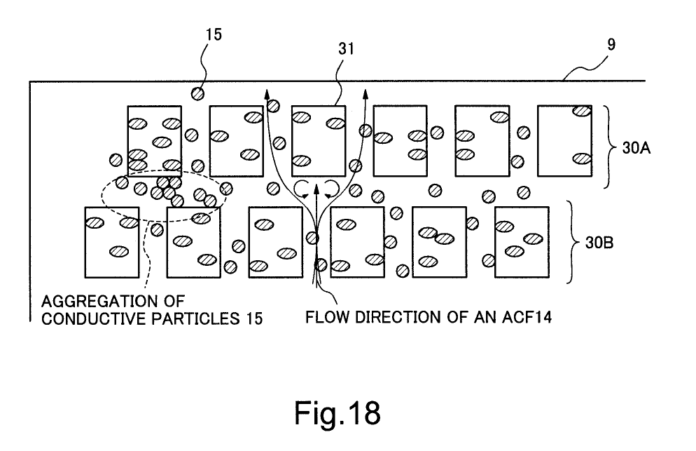

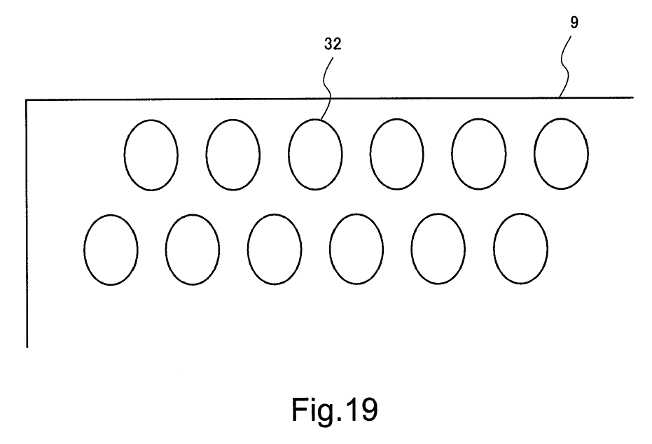

FIG. 17A is a perspective view of a bump 1K according to a fifth exemplary embodiment. FIG. 17B is a top view of the bump 1K, and FIG. 17C is the right side view of the bump 1K. In FIG. 17A through 17C, a gap 2G having curved inner walls is formed in the bump 1K.

In the bump 1K shown in FIG. 17, an insulating resin and conductive particles 15 of an ACF 14 can be introduced efficiently in the gap 2G. Therefore, it can be suppressed that a short circuit failure occurs between the bumps and between the bump lines.

Further, although the IC is described in the above-mentioned exemplary embodiments, the present invention can be applied to an optional device having a plurality of bumps as a terminal for connecting with different device. The LCD panel of the reflective type using the active matrix can be employed as the LCD device. A drive system of the LCD panel and a structure of the TFT can be different ones.

Moreover, although the bump according to the present invention is applied to the COG mounting is described, it is not limited to the COG mounting. It can be applied to mounting using the ACF, and applied to a COF mounting in which a semiconductor device is mounted on a flexible substrate.

Although the LCD device is described as a display device, the present invention can be applied to a display device such as a plasma display and an organic EL (electroluminescence) display. Moreover, the present invention can be applied to a general electronic apparatus in which a device with the bump is mounted via the ACF.

As mentioned above, the insulating resin and the conductive particles which flowed from the ACF pass the gap, and flow smoothly by forming the tapered gap in the bump arranged in the edge side of the device. Because the conductive particles do not aggregate between the bumps and the bump lines, it can be suppressed that a short circuit failure occurs between the bumps and the bump lines.

On the other hand, the part of the conductive particles which enter the gap can not pass the gap and are stopped therein because the gap is formed like a taper and its width becomes small in a direction through which the insulating resin and the conductive particles of the ACF flow. The conductive particles which stop in the gap aggregate therein and the aggregated conductive particles come to be pressed and held between the bump and the opposing electrode when reaching the upper surface of the gap of the aggregated conductive particles. Thereby, the electrode pad and the bump of the IC are connected electrically. At the same time, when the ACF is hardened, the device is fixed on the electronic apparatus.

When the bump structure of the related art described in the background art is used to mount an IC 9 on an electronic apparatus, the following problem occurs. That is, when a cross-sectional shape of a bump is made ellipsoidal, an upper surface area of the ellipsoidal bump is smaller than an upper surface area of a bump with a square cross-sectional shape. When the upper surface area of the bump is small, when the IC 9 is mounted on the electronic apparatus, the number of the conductive particles captured between the bump and an opposing electrode of the electronic apparatus decreases. Therefore, an electric continuity defect occurs between the IC 9 and the electronic apparatus.

On the other hand, when a bump is formed in an ellipsoidal shape having an upper surface area equal to an upper surface area of a square bump, a size of the ellipsoidal bump becomes large. Therefore, in order to form an ellipsoidal bump of a predetermined number, it is necessary to make a distance between bumps or a distance between bump lines short, and to make an area of a connecting face of an IC 9 wide. When the distance between bumps or the distance between bump lines is made short, it is easy to generate a short circuit failure. When the area of the connecting face of the IC 9 is made large, miniaturization of the IC 9 becomes difficult.

In contrast the above problem, in order to mount an IC on an electronic apparatus, when a bump with a taper-like gap according to the present invention is used, the following exemplary beneficial effects are obtained. That is, a short circuit failure is suppressed and an excellent conduction between devices can be given. Therefore, by using the bump with the taper-like gap, a small device with the bumps formed in a narrow pitch can be provided. Moreover, by mounting the small device according to the present invention on the electronic apparatus in high density, an electronic apparatus of small size, high quality and high reliability can be provided.

While the invention has been particularly shown and described with reference to exemplary embodiments thereof, the invention is not limited to these exemplary embodiments. It will be understood by those of ordinary skill in the art that various changes in form and details may be made therein without departing from the spirit and scope of the present invention as defined by the claims.

Further, it is the inventor's intention to retain all equivalents of the claimed invention even if the claims are amended during prosecution.

What is claimed is:

1. An electrode arranged on a device, comprising:
a gap which is tapered toward an edge of said device,
wherein said gap is formed from an end portion of said electrode to a different end portion thereof.

2. The electrode according to claim 1, wherein said gap divides the electrode into two parts completely.

3. The electrode according to claim 1, wherein said gap which is tapered toward a top face of said electrode.

4. The electrode according to claim 1, wherein said electrode is protruding, and wherein said gap is formed from said end portion on a first side face of said electrode to said different end portion on a second side face thereof.

5. The electrode according to claim 4, wherein said first side face and said second side face are opposed.

6. The electrode according to claim 4, wherein said first side face and said second side face are adjacent.

7. The electrode according to claim 6,
wherein said electrode includes an another gap which is tapered toward an edge of said device and is formed from an end portion on said first side face of said electrode to a different end portion on a third side face thereof, and
wherein said first side face and said third side face are adjacent, and said second side face and said third side face are opposed.

8. The electrode according to claim 1, wherein said width of said gap is tapered in a stepwise manner.

9. The electrode according to claim 1, wherein said side of said gap is tapered in a curved manner.

10. An electrode arranged on a device for electrically connecting with an electronic apparatus via an anisotropic conductive film including conductive particles and a resin, said electrode comprising:
a gap which is formed from an upper part of said electrode, wherein a part of said resin which is softened by heating flows through said gap, and wherein said gap is tapered in a direction which said resin flows therethrough.

11. The electrode according to claim 10, wherein a width of a part of said gap is narrower than an average diameter of said conductive particles.

12. The electrode according to claim 10, wherein said anisotropic conductive film adheres said device and said electronic apparatus.

13. A device, comprising:
a plurality of electrodes arranged thereon, at least one of said electrodes having a gap,
wherein said gap is tapered toward an edge of said device, and wherein said gap is formed from an end portion of said electrode to a different end portion thereof.

14. The device according to claim 13, wherein at least a part of said electrodes are arranged in a staggered configuration and at least a part of said electrodes with said gap are arranged on an edge side of said device.

15. A device, comprising:
a plurality of electrodes arranged thereon, said electrode connecting said device and an electronic apparatus electrically via an anisotropic conductive film including conductive particles and a resin,
wherein at least one of said electrodes includes a gap which is formed from an upper part of said electrode,
wherein a part of said resin which is softened by heating flows through said gap, and
wherein said gap is tapered in a direction which said resin flows therethrough.

16. The device according to claim 15, wherein a width of a part of said gap is narrower than an average diameter of said conductive particles.

17. The device according to claim 15, wherein said anisotropic conductive film adheres said device and said electronic apparatus.

18. The device according to claim 15, wherein at least a part of said electrodes are arranged in a staggered configuration and at least a part of said electrodes with said gap are arranged on an edge side of said device.

19. An electronic apparatus, comprising: a conductive part; and a device including a plurality of electrodes electrically connecting with said conductive part via an anisotropic conductive film including conductive particles and a resin, wherein at least one of said electrodes has a gap which is formed from an upper part of said electrodes, and wherein a part of said resin which is softened by heating flows through said gap, and wherein said gap is tapered in a direction which said resin flows therethrough.

20. The electronic apparatus according to claim 19, wherein at least one of said gaps is filled with said conductive particles to an upper part of said gap.

21. The electronic apparatus according to claim 19, wherein said anisotropic conductive film adheres said device and said electronic device.

22. The electronic apparatus according to claim 19, wherein said electronic device is a liquid crystal display device, said liquid crystal display device including a couple of substrates having a liquid crystal layer therebetween, wherein said conductive part is formed on at least one of said substrates.
